(19) United States
(12) Patent Application Publication
(10) Pub. No.: US 2012/0258227 A1
(43) Pub. Date: Oct. 11, 2012

(54) PRODUCT COOLING SYSTEM, METHOD AND APPARATUS TO REDUCE HEAT TRANSFER

(75) Inventors: Jeffery W. Kadyk, Springfield, IL (US); Sheryl L. Dyer, Springfield, IL (US)

(73) Assignee: BUNN-O-MATIC CORPORATION, Springfield, IL (US)

(21) Appl. No.: 13/516,293

(22) PCT Filed: Dec. 16, 2010
(86) PCT No.: PCT/US10/60870

§ 371 Date: Jun. 15, 2012

Related U.S. Application Data
(60) Provisional application No. 61/287,081, filed on Dec. 16, 2009.

(51) Int. Cl. B67D 7/80; A23L 2/00

(52) U.S. Cl. 426/524; 222/146.6

(57) ABSTRACT

A beverage dispensing apparatus including a cabinet for retaining a beverage product and from which the beverage product is controllably dispensed. The cabinet includes structures and systems to make cooling more efficient and maintain more constant product temperatures. The structures and systems function to reduce heat transfer between beverage product stored in containers in the cabinet and the ambient environment. The apparatus maintains a minimal equipment footprint, maintains ease of installing and removing the beverage containers, and accommodates a variety of types of products and types of product containers.

### CROSS REFERENCE TO RELATED APPLICATIONS

The present application claims priority under 35 U.S.C. §119(e) to U.S. Provisional Patent Application No. 61/287,081, filed Dec. 16, 2009. The disclosure set forth in the referenced application is expressly incorporated herein by reference in its entirety, including all information as originally submitted to the United States Patent and Trademark Office.

### BACKGROUND

A beverage dispensing apparatus including a cabinet for retaining a beverage product and from which the beverage product is controllably dispensed. In particular, the disclosure relates to improvements in structures of such apparatus to make cooling more efficient and maintain more constant product temperatures. These improvements are achieved while still maintaining minimal equipment footprint, maintaining ease of installing and removing the beverage containers, and accommodating a variety of types of products and types of product containers.

By way of background, some beverage products, such as juice, dairy-based beverages, and other beverage food concentrates are retained in a chilled condition. Such beverage products are retained in a product cabinet of a beverage dispensing apparatus which is cooled for convenient storage and controlled on demand dispensing. Cooling may provided using a variety of techniques including removing heat by way of air conditioning, ice banks, or other cooling systems. Regardless of the cooling techniques or systems used, the temperature of the product retained in the cabinet should be maintained in a generally consistent reduced temperature. This may be desirable to at least maintain favorable characteristics of the product. For example, product life of the beverage product may be maintained through cooling, flavor characteristics might be maintained, as well as color characteristics.

An example of a beverage product that might be retained in a cooling cabinet of a beverage dispensing apparatus or beverage dispenser is an orange juice concentrate. Orange juice is provided to the beverage dispenser in a concentrated form. In other words, the concentrated orange juice beverage product is packaged, retained in a product container and stored in a beverage dispensing apparatus for on demand controlled mixed with water when dispensed to reconstitute a juice beverage. Beverage concentrates help to at least reduce the cost of shipping product by reducing the proportion of water bulk and weight in the product and allowing the water to be added to the concentrate on site when dispensing to produce a reconstituted beverage.

In order to help maintain desirable characteristics, the concentrate is packaged in sealed containers such as plastic containers referred to as “caddies” or bag-in-box (BIB) containers. A product stored in a more bag-like container may also be used. Generally, such bag-like containers can be transferred to a caddie for use in beverage dispensing apparatus. The containers generally retain the concentrate in a sealed condition until it is placed in the juice cabinet and connected to a water line for controlled dispensing and mixing. Similarly, the BIB packaging contains the juice concentrate in a sealed container. BIB packaging may include a cardboard box or other container providing some degree of structural support for the flexible plastic bag retained in the box. Both the caddie and the BIB packaging or containers include fitments or connectors which can be connected to a dispensing nozzle, water source, and equipment used to dispense and mix the concentrate.

Such beverage product concentrates need to be maintained at a consistent temperature based on food product sales requirements. The containers, when placed in the cabinet cavity may swell, bow, or flex outward. Since several containers may be placed in the same cabinet the outermost containers, those placed along the inside wall surfaces of the cabinet, tend to contact the inside walls of the cabinet. This provides a relatively large potential contact area which can have a potentially negative effect on the product temperature. Contact between the container wall and the inside wall of the cabinet prevents airflow around the container. Additionally, the contact between the container wall and the inside wall of the cabinet provides a potentially, relatively large contact area permitting heat transfer between the wall and the product through the container wall. While insulation is provided in the cabinet walls, a significant temperature difference may occur between the product container in an exterior position of a group of containers and interiorly positioned containers. The temperature differential may be of several degrees which could be undesirable for maintaining product characteristics.

This background information is provided to provide some information believed by the applicant to be of possible relevance to the present disclosure. No admission is intended, nor should such admission be inferred or construed, that any of the preceding information constitutes prior art against the present invention. Other aims, objects, advantages and features of the invention will become more apparent upon reading of the following non-restrictive description of specific embodiments thereof, given by way of example only with reference to the accompanying drawings.

### BRIEF DESCRIPTION OF THE DRAWINGS

The present disclosure will be described hereafter with reference to the attached drawings which are given as a non-limiting example only, in which:

FIG. 1 is a front plan view of a beverage dispensing apparatus, showing a dispensing area positioned proximate to and below a cooled cabinet portion, the dispensing area having a control panel positioned proximate to and above dispensing nozzles;

FIG. 2 is a cross sectional side elevational view of the apparatus in FIG. 1, in which the view is taken along line 2-2 in FIG. 1 to illustrate interior structures, configurations, and associated functions including air flow and circulation paths to provide for circulating cooling air around product containers retained in the cabinet; and

FIG. 3 is a front elevational view of the apparatus with a front door of the apparatus opened to illustrate the interior structures, configurations and associated functions of the cabinet.

The exemplification set out herein illustrates embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure. The disclosure is not limited in its application to the details of structure, function, construction, or the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of various phrases and terms is meant to encompass the items or functions identified and equivalents thereof as well as additional items or functions. Unless limited otherwise, various phrases, terms, and variations thereof herein are used broadly and encompass all variations of such phrases and terms. Furthermore, and as described in subsequent paragraphs, the specific configurations illustrated in the drawings are intended to exemplify embodiments of the disclosure. However, other alternative structures, functions, and configurations are possible which are considered to be within the teachings of the present disclosure. Furthermore, unless otherwise indicated, the term “or” is to be considered inclusive.

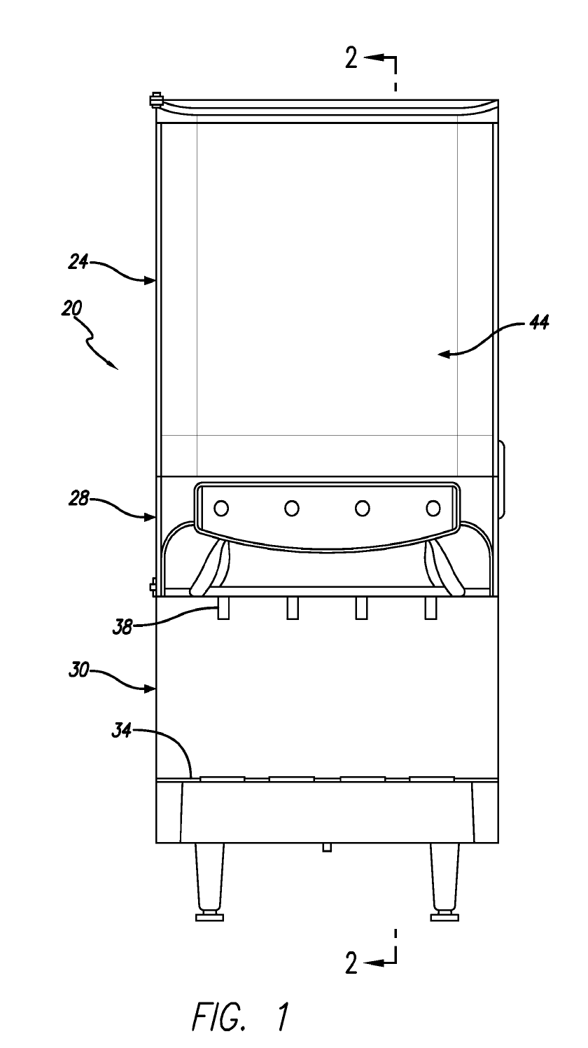

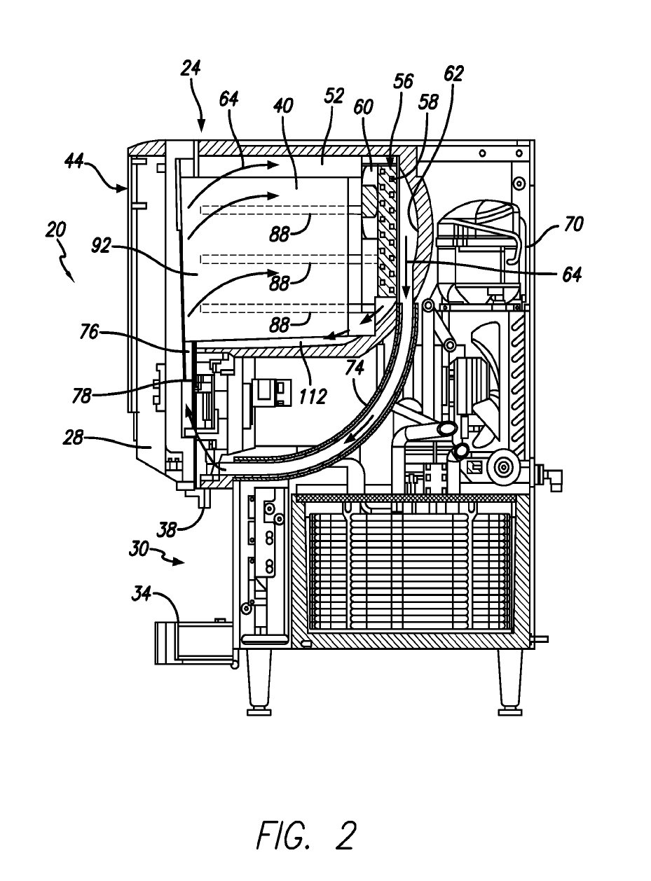

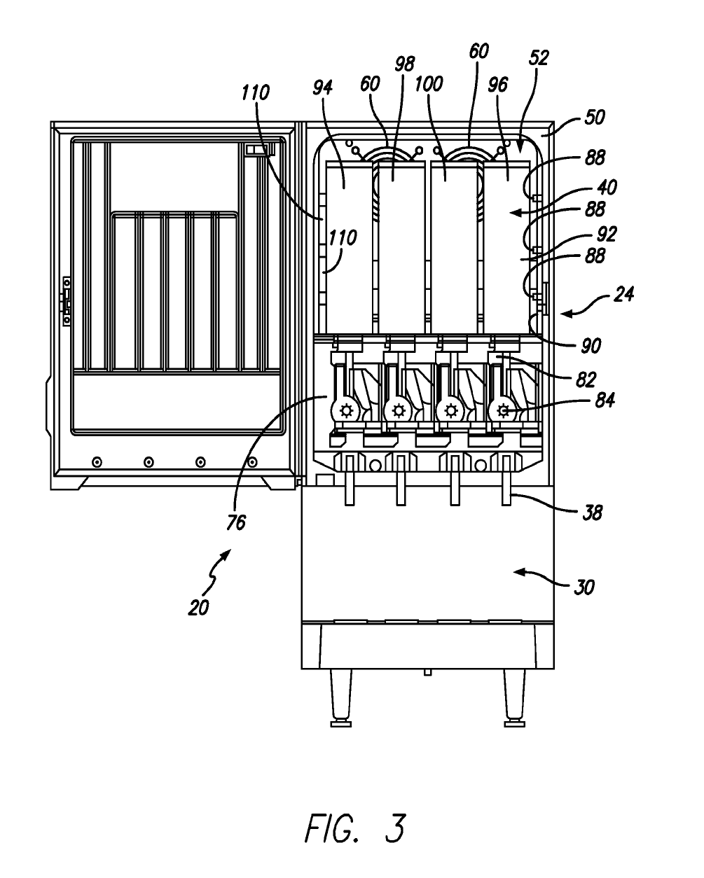

With reference to FIG. 1, a beverage dispensing apparatus 20 is shown. The apparatus 20 includes an upper cabinet area 24, a control area 28, and a dispensing area 30. The dispensing area 30 includes a cup ledge 34 and overhanging dispensing nozzles 38 positioned above the cup ledge 34. A beverage product 40 (see FIGS. 2 and 3) is retained in the upper cabinet area 24 behind a door 44 positioned on the front of the cabinet 24.

With reference to FIG. 2, the apparatus 20 as shown in a cross-sectional view taken along line 2-2 in FIG. 1. The cross-sectional view shows a beverage product container 40 positioned inside of the upper cabinet area 24 behind the door 44. With further reference to FIG. 3, the upper cabinet area 24 includes an insulated wall 50. The insulated wall defines a cavity 52 which is sized and dimensioned for retaining a beverage product container. A cooling unit 56 is positioned for communication with the cavity 52 to provide controlled cooling of the cavity 52. Cooling coils 58 run through the cooling unit 56 and fans 60 blow against the cooling coils 58. As such the direction of flow of the fan driven air is towards the rear curved area 62 of the cavity 52. This rear directional flow of air 64 is a reduced temperature. The temperature is as a result of the heat exchange created by the cooling system 70.

Air 64 cooled by the cooling unit 56 is directed into a directional channel 74. The directional channel connects the curved rear area 62 of the cavity 52 with a front area 76 of the cavity. Air exits the channels 74 in a direction upwardly over the product dispensing area 78. The product dispensing area includes tubes 82 coupled to the product containers 40 and configured for use with a peristaltic pump 84. The tubes provide the dispensing nozzle 38 in the dispensing area 30. Passage of the cooled air through this dispensing area 76 helps to maintain the product, which is not retained in the container, such as the product fitting in the tubes, remains chilled at a desirable temperature to maintain various beverage characteristics. The protrusions may also be retro-fitted into an existing cabinet by attachment to an inside surface of the wall by adhesive, fasteners or other means of attachment. The protrusions may also be provided on a panel which is attached to the inside wall of the cabinet cavity.

At least one protrusion 88, illustrated in the form of ribs 88 are provided on an inside surface 90 of the wall 50. These ribs 88 provide a structural member to space the product container walls away from the insider surface 90. Even if the container 40 tends to sag, bow or otherwise become distorted towards the inside surface 90 of the wall 50, the ribs 88 will help maintain a space between the outside surface of the container 40 and the inside surface 90 of the dispenser wall 50. The air 64 continues to flow around the containers 40 and back to the fans 60.

As such, the ribs 88 help to prevent heat exchange between the wall 50 and the outside surfaces 92 of the containers 40. This helps to maintain the temperature of the outside containers 94, 96 at approximately the same temperature as the inner containers 98, 100. Air is recirculated through the cavity 52 in the path as described. The protrusions 88 are shown as ribs but could be provided in a variety of other embodiments that provide a structure to space the product container walls away form the inside surface of the cavity. Reference to protrusions 88 is to be broadly interpreted to include ribs and all variations of other protrusions, regardless of whether they can be identified or defined as ribs, as long as these structures provide the spacing function needed to help maintain a preferred, desired, or required product temperature.

In use, a user places a beverage container 40 into the cavity 52 of the apparatus 20. Once placed in the cavity, the door 44 is closed. The cooling cycle is initiated whereby the cooling unit 70 operates to reduce the temperature of material flowing through the cooling coils 58. Fans 60 of the cooling assembly 56 blow across the coils to reduce the temperature of air moved by the fans 60. Air flows through the cooling assembly 56 in through the channel 74. In other words, the fans 60 force a flow pattern of the air 64 flowing through the cavity 52. The air 64 flowing from the channel 74 flows past the dispensing assembly 78 and up around the container 40 outside the surfaces 92.

The walls 50 include the protruding ribs 88 positioned thereon. The ribs 88 extend marginally outwardly away from the inside surface 90 of the cabinet 24 to help provide a passage between the outside surface 92 of the product wall and the inside surface of the cabinet wall. The ribs 88 provide channels 110 defined by the ribs 88, the outside surfaces 92 of the packaging containers 40, and the inside surface 90 of the cabinet walls, to promote airflow 64 there between. Also, the ribs 88 significantly reduce the potential contact area between the product packaging and the cabinet. Similarly, ribs 112 can be provided on a bottom surface of the cabinet to allow airflow underneath the product packaging containers. The ribs 88 can be directionally oriented, as shown by way of illustration and not limitation to help induce directional flow of air along the packaging. Similarly, airflow can be directed by way of the blowing of cooled air or suction of cooled air through the cabinet.

In at least one configuration, the airflow can be directed from the rear of the cabinet 62, through a passage 74 along the bottom of the product packaging, upwardly along the front face of the packaging and back through the upper, rear portion of the cabinet cavity 52. This airflow may be desirable so as to provide cooled air towards the front portion of the cabinet where the connectors or fitments are connected to the product packaging. This helps provide cooling in the front portion 78 where the product may be dispensed and slightly exposed to elevated temperatures where the product tube 82 passes from the cabinet towards the ambient atmosphere.

While the present disclosure describes various exemplary embodiments, the disclosure is not so limited. To the contrary, the disclosure is intended to cover various modifications, uses, adaptations, and equivalent arrangements based on the principles disclosed. Further, this application is intended to cover such departures from the present disclosure as come within at least the known or customary practice within the art to which it pertains. It is envisioned that those skilled in the art may devise various modifications and equivalent structures and functions without departing from the spirit and scope of the disclosure as recited in the following claims. The scope of the following claims is to be accorded the broadest interpretation so as to encompass all such modifications and equivalent structures and functions.

1. A beverage dispensing apparatus including a cabinet having walls defining a cavity size and dimension for retaining at least one beverage product container, a cooling unit is associated with the cabinet for communication with the cavity to provide controlled cooling of the cavity, opposing inside surfaces of the cavity walls including at least one protrusion for spacing product container walls away from the inside surface of the walls, the cooling system circulating air through the cabinet with the protrusions providing space between a product placed in the cavity and the inside surface of the cavity wall.

2. A method of maintaining a temperature associated with a product stored in a beverage dispensing apparatus, the method including the steps of:
providing a beverage dispensing apparatus including a cabinet having walls defining a cavity therein;
providing protrusion on an inside surface of a cavity;
providing a cooling unit associated with the cabinet;
circulating air by means of the cooling unit through the cavity of the cabinet;
placing at least one product container in the cabinet with an outside of the product containing abutting the protrusion to provide a space between the container and the cabinet to facilitate movement of air by the cooling unit and prevent heat transfer between the product and the cabinet.

3. A protrusion device for use in a beverage dispensing cabinet, the protrusion device including at least one protrusion sized dimension for attachment to an inside surface of the beverage dispensing apparatus cabinet, the protrusion being size and dimension to provide a spaced gap between a product placed in the cabinet and an inside surface of the cabinet to which the protrusion is attached.

4. The protrusion device as in claim 3 further comprising a linear rib which is attached to an inside surface of the cabinet of the beverage apparatus.

5. The protrusion device of claim 3 further comprising a panel having at least one protrusion extending from the panel, the panel being sized and dimension for attachment to an inside surface of a cabinet of a beverage dispensing apparatus.
